(19) United States
(12) Patent Application Publication
(10) Pub. No.: US 2015/0168132 A1
(43) Pub. Date: Jun. 18, 2015

(54) METHOD AND SYSTEM FOR USE IN OPTICAL MEASUREMENTS IN DEEP THREE-DIMENSIONAL STRUCTURES

(71) Applicant: NOVA MEASURING INSTRUMENTS LTD., Rehovot (IL)

(72) Inventors: Gilad Barak, Rehovot (IL); Boaz Brill, Rehovot (IL)

(21) Appl. No.: 14/378,486

(22) PCT Filed: Feb. 12, 2013
(86) PCT No.: PCT/IL2013/050129

§ 371 Date: Aug. 13, 2014

Related U.S. Application Data
(60) Provisional application No. 61/597,854, filed on Feb. 13, 2012.

(51) Int. Cl. G01B 11/22; G01N 21/95; G01N 21/21; G01B 11/30

(52) U.S. Cl. CPC G01B 11/22; G01B 11/30; G01N 21/9501; G01N 21/21; G01N 2201/061

(57) ABSTRACT

A measurement system and method are presented for use in measuring in patterned structures having annularly-shaped vias. The system comprises illumination and detection channels, a polarization orientation system, a navigation system, and a control unit. The polarization orientation system provides at least one of a first polarization orientation condition corresponding to a first measurement mode enabling determination a depth of the via, and a second polarization orientation condition corresponding to a second measurement mode enabling determination of one or more parameters of a profile of the via, the first and second polarization orientation conditions defining first and second predetermined orientations respectively for polarization of the incident light relative a sidewall of the via.

### TECHNOLOGICAL FIELD

This invention is generally in the field of optical inspection (including also metrology) of patterned structures, and relates to a method and system for use in optical measurements of deep three-dimensional structures, particularly useful for semiconductor structures having vias.

### BACKGROUND

As semiconductor technology progresses, shrinking device dimensions has become an increasingly complex task. One approach to overcome these difficulties is by using vertical integration of multiple semiconductor devices (chips). This allows larger number of devices per unit (e.g. in memory applications), as well as integration of chips of different functionality thus allowing better performance of a hybrid system (e.g. sensor, processor and memory).

One method under development for vertical integration is based on Through Silicon Via (TSV). TSV is a vertical electrical connection (via) passing completely through a silicon wafer or die. TSV is a high performance technique to create 3D packages and 3D integrated circuits (as compared to its alternatives such as package-on-package), because the density of vias is substantially higher and the length of the connections is shorter. According to TSV, conducting pillars are formed within a silicon substrate, later to be used for contacting successive chips. To connect electrically the components in different layers, TSV technology is used to provide the electrical interconnect and to provide mechanical support. In TSV technology, a via is fabricated in a silicon chip with different active integrated circuit devices or other devices fabricated by a semiconductor process, and the via is filled with metal such as Cu, Au, W, solders, or a highly-doped semiconductor material such as polysilicon. Multiple components provided with such vias are then stacked and bonded together.

One critical step in the TSV process is via formation, in which a pattern of contacts is etched into the silicon. In order to maintain the required via quality, it is essential to control both the depth and profile of the vias.

WO 2012/098550, assigned to the assignee of the present application, discloses an optical system for use in measuring in patterned structures having vias. The system is configured and operable to enable measurement of a via profile parameters. The system comprises an illumination channel for propagating illuminated light onto the structure being measured, a detection channel for collecting light returned from the illuminated structure to a detection unit, and a modulating assembly configured and operable for implementing a dark-field detection mode by carrying out at least one of the following: affecting at least one parameter of light propagating along at least one of the illumination and detection channels, and affecting propagation of light along at least the detection channel.

### GENERAL DESCRIPTION

There is a need in the art in a novel technique for optical measurements in deep three-dimensional structures, in particular useful for measuring in semiconductor structures having narrow annularly-shaped vias.

TSV are created by deep silicon etch, yielding a vertical hole in the silicon with high aspect ratio. Via is typically defined by such parameters as its top diameter, bottom diameter, depth, and sidewall ripples (i.e. an oscillatory indent pattern appearing on the via walls as a result of the TSV fabrication process), sidewall angle, top undercut. Typical via diameters are 1-50 μm, and depths are up to 200 μm, with aspect ratios up to 15:1.

Characterization of the top-diameter of via is possible using several techniques, including, for example, bright-field optical imaging, in which light is incident on the via from above and the specularly reflected light is detected and analyzed. However, due to the large aspect ratios, typical for TSV, information on depth cannot be similarly acquired, and several other approaches have been suggested for this purpose, mostly based on interferometric methods. As the via top-diameter is decreased, the signal reaching the via bottom is reduced leading to significant difficulty in measurement of deep and narrow vias. The growing interest in utilizing narrow vias in high-end semiconductor devices necessitates a corresponding adequate metrology technique.

The fabrication process of through-Silicon vias of 10-20 μm diameter, depth from few tens of microns up to about 150 μm, and about 2-8 μm width incorporates various considerations, leading to different possibilities of via shapes and dimensions. One structure found to have considerable benefits to the fabrication process is an annularly-shaped via. In this connection, reference is made to FIGS. 1A and 1B showing respectively a schematic profile of a via 10 and a top view of the via-containing portion of a structure. The width of the resulting ring (particularly bottom width) can be relatively narrow, limiting the effectiveness of optical metrology measures from reaching the via bottom, and rendering the measurement of the via depth difficult.

To ensure reliable and repeatable integration process, several crucial via profile parameters require monitoring and control, such as the via depth, top diameter, sidewall angle, sidewall ripples (i.e. an oscillatory indent pattern appearing on the via walls as a result of the TSV fabrication process), bottom diameter and top undercut. As shown in the figures, the via is typically defined by its top diameter, bottom width, depth, and sidewall ripples. The via depth should exceed the final planned thickness of the layer in the chip stack, so that after thinning the wafer, it will form a connection between the two sides of the chip. The sidewall ripples should be reduced as much as possible to provide a substantially smooth side wall profile to ensure optimal filling of the via. The top and bottom diameters usually define a side wall angle which should be well-controlled (to meet the requirements of the coating and filling processes of the TSV in the following fabrication steps), and provide the side-wall slope very close to vertical in order to guarantee good conductive properties of interconnect. A possible consequence of the etching process is the creation of an undercut at the top edge of the via (top undercut). Such undercut may impair the following filling process.

Light penetration into the via is mainly determined by its interaction with the via walls. The inventors have found that when measuring the parameters of an annularly-shaped via, the use of specific polarization of incident light relative to the sidewalls of the via enables measurement of the via depth or via profile accordingly. Also, the inventors have found that the use of specific polarization of incident light relative to the sidewalls of the via along with a predetermined relation between the polarization of the incident and detected light could further provide effective measurements of the via depth or via profile.

When incident light is polarized in a direction parallel to the via wall, it induces local currents in the semiconductor structure (typically Si). This interaction causes light absorption and thus affects the light passage. In contrast, light polarized perpendicular to the via wall weakly interacts with the semiconductor structure (Si), and will thus reach the via bottom with less loss.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A and 1B are schematic illustrations of the main features/parameters of an annularly-shaped via;

FIG. 2 shows a schematic block diagram of measurement system of the present invention;

FIGS. 3A to 3C illustrate principles of selection of the polarization orientation of incident light;

FIG. 4 exemplifies a system using polarizer and analyzer, suitable for measuring annularly-shaped via,

FIG. 5 exemplifies another possible configuration of a measurement system using phase retarder, and

FIG. 6 shows an example of measurement system based on single polarizer and phase retarder.

### DETAILED DESCRIPTION OF EMBODIMENTS

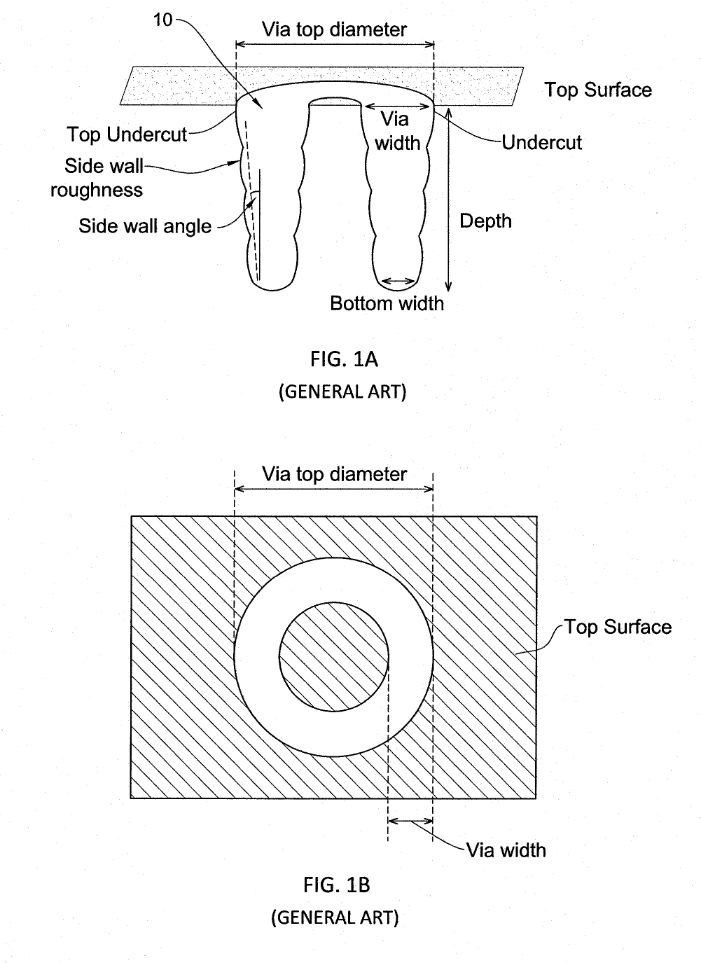

FIGS. 1A and 1B illustrate the main features/parameters of an annularly-shaped via 10. These parameters include the via depth, via width, top diameter, sidewall angle, sidewall ripples, and top undercut.

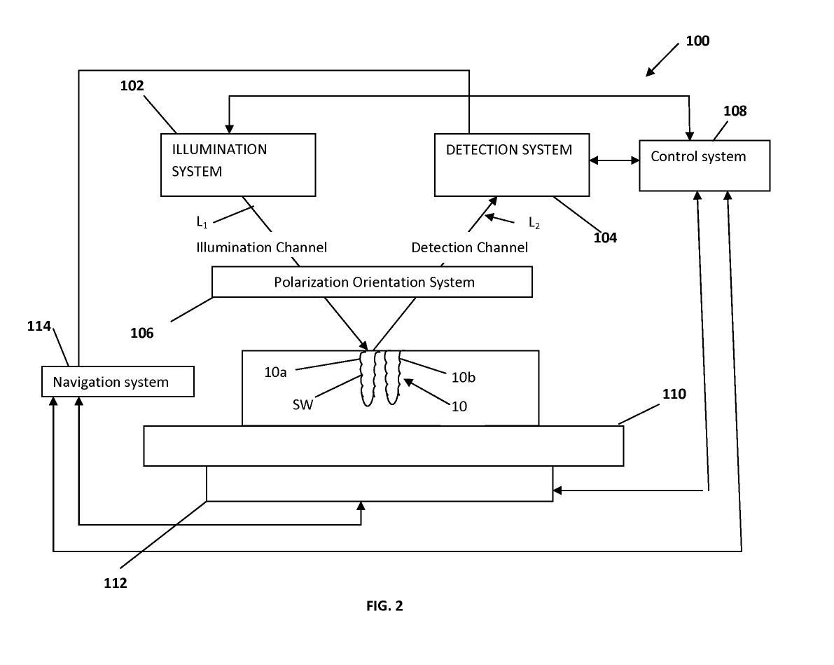

Reference is made to FIG. 2 showing schematically, by way of a block diagram, an optical measurement system 100 of the present invention configured and operable for measuring in patterned structures having annularly-shaped vias. The system 100 includes an illumination system 102 defining an illumination channel for propagating incident light L₁ onto structure S (e.g. wafer) being measured, a detection system 104 defining a detection channel for collecting light L₂ returned from an illuminated region (measurement site/spot) on the structure S, an orientation system 106, a navigation system 114, and a control system 108. The control system 108 is connected to the output of the detection system and possibly also to the orientation system 106 and navigation system 114. Preferably, the incident light is broadband light, and the detection system thus could include a spectrometer. The orientation system 106 includes an optical unit associated with the illumination channel to provide a predetermined orientation of the polarization of incident light relative to sidewall SW of the via 10, and also associated with the detection channel to provide relative orientation between the polarizations of the incident and detected light.

The structure is typically located on a support stage 110 which allows control (handle) of the sample in the measurement plane. The construction and operation of such stage are known per se and therefore not need to be described in details except to note that the stage 110 could be associated with a drive mechanism 112 which is typically operated by the control system 108 to displace the structure under measurements with respect to the illumination and detection channels, i.e. with respect to the optical paths of light propagation. Support stage 110 along with drive mechanism 112 may perform at least one of X, Y, Z, θ R-θ or any other required displacement of the structure.

In the system 100, preferably normal incidence mode is used, i.e. the incident light impinges on the surface of the structure substantially perpendicular to its top surface. As for the detection mode, it may be configured for collecting light specularly reflected (zero diffraction order) from the wafer. It should be understood that the light propagation scheme is shown in the figure schematically, and also various optical elements that might be used in the system (such as lenses, splitters, deflectors) are not shown here, as it would be obvious for a person skilled in the art how to arrange the optical system to meet the requirements/conditions of the present invention described herein in details. The illumination and detection channels may be partially overlapping, and utilize a common objective, which is not shown in the figure.

The invention is aimed at measuring annularly shaped via 10 formed by a narrow annular trench, two parts 10a and 10b thereof being seen in the cross sectional view. According to the invention, linearly polarized incident light L₁ is used with a predetermined polarization orientation relative to the side walls of the via, and certain relation between the polarizations of the incident and detected light is provided. Accordingly, the orientation system 106 could include a controllable polarization unit in the illumination channel, and a controllable polarization unit (analyzer) in the detection channel. Also, preferably, a center of the measurement spot is to be placed above the center of the via trench 10a (or 10b). To this end, the navigation system is operated as mentioned above to enable proper alignment between the incident beam and the via trench 10a (or 10b).

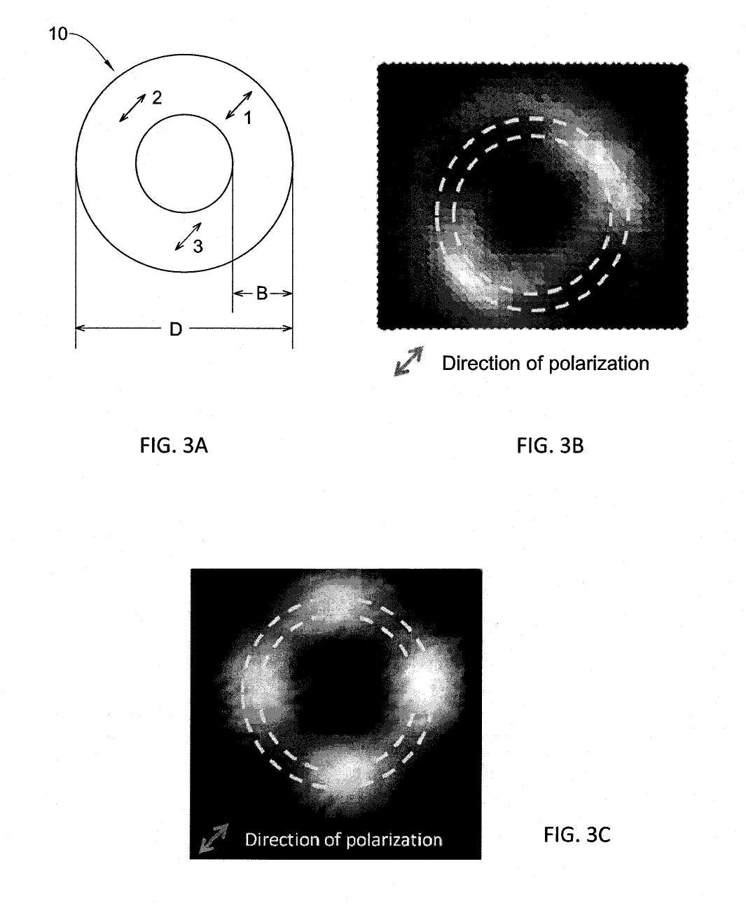

In this connection, reference is made to FIGS. 3A to 3C illustrating the principles of selection of the polarization orientation of incident light and of the position of the measurement spot. The spot size is preferably larger than the via width B and smaller than the top via diameter D.

When probing the annularly-shaped via 10, light interaction with the via walls is weak when the polarization of light is substantially perpendicular to the wall (location 1 in FIG. 3A) and is strong when the polarization of light is substantially parallel to the wall (location 2 in FIG. 3A). Thus, in order to detect light returned from the via bottom the incident light having polarization oriented substantially perpendicular to the via wall is used. Preferably, substantially the same orientation of the polarizations of the incident and detected light (so called bright field conditions) could be used. In some cases, also a so-called “gray-field” detection mode could be used. The gray-field detection condition presents a predetermined combined dark and bright field detection condition for the light response signal. This combined dark and bright field detection condition is such as to provide a predetermined ratio between the intensity of a first light portion formed by light specularly reflected from the top surface of the structure, and the intensity of a second light portion formed by light returned from the via bottom. In other words, the light portion returned from the top surface is significantly reduced as compared to that of light returned from the via bottom, in the entire detected light signal. The principles of the gray-field mode are described in the co-pending U.S. application 61/509,127 assigned to the assignee of the present application, which application is incorporated herein by reference. In the present invention, the gray-field mode is achieved by providing a close to (but not equal) 90 degree orientation between the polarizations of the incident and detected light (close to cross-polarization condition).

The detected signal in case of via depth measurement is a result of interference between light returned from the top surface and from the via bottom enabling direct depth determination from the interference pattern.

When using incident light having polarization oriented at 45° to the via walls (location 3 in FIG. 3A) its polarization is strongly rotated, due to the different extinction of the two polarization components. In this case, the cross-polarization condition, i.e. 90 degree orientation between the polarizations of the incident and detected light provides for significantly reducing a part of specular reflections in the detected light. Keeping in mind that specular reflection returned from the side walls of the via is negligible relative to that from the top surface, this cross-polarized condition provides a desirably high signal to noise ratio with respect to the light returned from the via walls.

FIGS. 3B and 3C illustrate contrast of the depth-related and profile-related spectral oscillations respectively, when the measurement spot is scanned across an annular via. As shown in FIG. 3B, two regions, where polarization (indicated by the arrow) is directed perpendicular to the via walls, show good contrast for light returned from the bottom of the via, thus enabling determination of the via depth. Dashed lines mark the via boundaries. As shown in FIG. 3C, regions where polarization of incident light is at 45 degree orientation to the via walls, show good contrast for light returned from the sidewalls of the via, thus enabling determination of the via profile.

Thus, the optical unit of the orientation system 104 may include a beam shaping or focusing optics to adjust the size of the illuminated spot. Also, the system 100 may include an alignment utility for properly adjusting the location of the illuminating beam L₁ and the structure such that the center of the illumination spot is aligned with the center of the via trench. Such an alignment utility may be associated with the navigation system, connected to either the drive mechanism of the stage or at least a part of the optical system. Thus, generally, the system 100 includes an alignment mechanism enabling navigation of the incident light over the top surface of the structure. For this purpose, image acquisition/processing utilities, as well as structure and/or optics translating unit with appropriate resolution can be used. As indicated above, the measurement spot size is preferably larger than the via width, allowing reflectometry measurement where light portions reflected from both the wafer top surface and the via bottom are detected substantially simultaneously, and the measurement spot is smaller than the via top diameter, so that only regions in the via where light can penetrate to the bottom are illuminated.

FIG. 3B presents the contrast of the spectral oscillations arising from interference between light reflected from the via bottom and the top surface of the structure. This example corresponds to the incident light polarization substantially perpendicular to the via walls (position 1 in FIG. 3A). In this case, light weakly interacts with the sidewalls of the via allowing the incident light propagation to the via bottom, and accordingly propagation of light returned from the via bottom to the detection system. Detection of light mainly returned from the bottom of the via allows determination of the via depth.

FIG. 3C presents the contrast of the spectral oscillations of signal measured in the crossed-polarizers scheme. Signal is significantly stronger on the four corners where polarization is in 45° to the incident polarization direction, thus enabling determination of the via profile.

Thus, the technique of the invention provides a novel measurement technique for measuring at least such parameters of an annularly shaped via as the depth of the via trench and the profile of the via profile (including the sidewalls ripples, angle and undercut). For such measurements, polarized incident light is used with a predetermined orientation of its polarization relative to the sidewalls of the via.

Also, substantially small numerical aperture (e.g. 0.02) could be used in case of via depth measurement to ensure incident light propagation inside the via. Further, the spot size is preferably smaller than the via top diameter and larger than the via trench width.

For the via depth measurements, the polarization of incident light is substantially perpendicular to the via walls, and the same orientation of the polarizations of the incident and detected light (so called bright field conditions) is used. In some cases, also close cross-polarization detection mode (gray field) could be used. The output of the detection system (spectrometer) is indicative of oscillations of the interference pattern, which are in turn indicative of the via depth.

For the via profile measurements, the polarization of incident light is 45 degree oriented to the via walls, and the cross-polarization detection mode is used. In this case, the control system is preprogrammed to apply a certain model to data indicative of the output of the detection system (spectral signature). The model is in the form of a set of parameters each affecting a spectral signature. The sidewall profile parameters (e.g. sidewall angle, ripples, etc.) could be determined by comparing (fitting) the detected signature to the simulated/modeled signature and varying the model parameters upon arriving to the best fit condition. The sidewalls parameters corresponding to the best fit condition are then determined from the respective modeled signature.

The following are some specific but not limiting examples of the optical arrangement used in the measurement system of the invention. The same reference numbers are used to identify components that are common in all the examples.

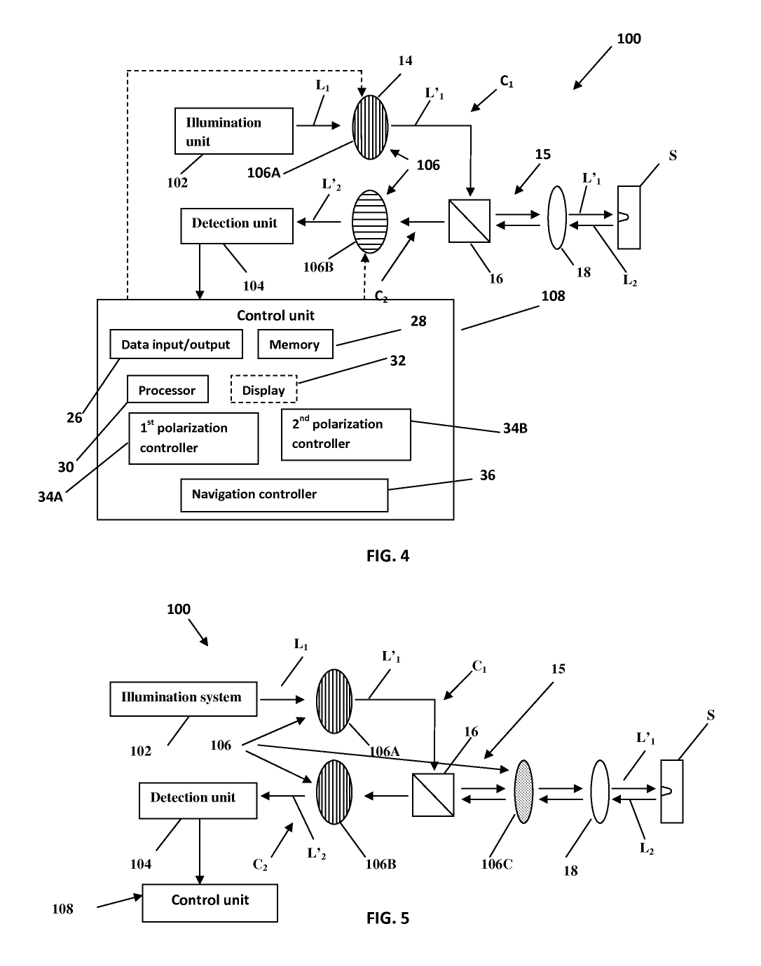

FIG. 4 exemplifies a system 100 for measuring in a wafer S having an annularly shaped via (10 in FIGS. 1, 3A-3C). The system 100 defines illumination and detection channels C₁ and C₂, and is configured to affect the polarization of light propagating along the illumination and detection channels. The system 100 includes an illumination unit 102 (which may be constituted by a light emitting arrangement or by a light guiding unit associated with an external light emitter) which preferably produces broadband illumination, a detection unit 104 which preferably includes a spectrometer, a polarization orientation system 106, and a control unit 108. The polarization orientation system 106 in present example includes a controllable polarizer 106A in the illumination channel and a controllable polarizer (analyzer) 106B in the detection channel.

The control unit 108 is connectable to the output of the detection unit 104 (via wires or wireless signal transmission) for receiving and analyzing data indicative of the detected light, and also to the controllable polarizers 106A and 106B. The control unit 108 is typically a computer system including such functional utilities as data input and output utilities 26, memory 28, processor 30 and possibly also a display 32. The control unit 108 further includes first and second polarization controllers 34A and 34B associated with polarizers 106A and 106B for selectively varying the orientation of their planes of polarization to provide certain orientation of the plane polarization of the polarizer 106A relative to the sidewalls of the annularly shaped via and certain mutual orientation of the planes of polarization of the polarizers 106A and 106B. Also provided in the control unit is a navigation controller 36, which is associated with the stage drive mechanism, and/or optical elements to provide relative displacement between them, and is also associated with an imager (not shown) in the detection unit to apply image processing technique to data indicative of the image of the measurement site. As described above, the navigation controller operates to align the center of the measurement spot with the center of the via trench, and also to identify the via walls orientation. It should also be noted, although not specifically shown, that the control unit 108 may include a focusing controller associated with focusing optics (objective) to provide the desired spot size.

Thus, initially, the navigation controller 36 operates to align the illumination and detection channels such that center of the illumination spot is aligned with the center of the via trench, and the system further operates to determine the via walls orientation. Then, the incident-path polarizer 106A is operated by the control unit 108 (its polarization controller 34A) to adjust the orientation of the polarization of light incident relative to via walls orientation. Thus, light L₁ coming from the illumination system 102 propagates along the illumination channel C₁, and is polarized by the incident-path polarizer 106A, and resulting polarization-oriented light L′₁ is directed onto the wafer S by a beam splitter 16 which reflects it towards objective 18 that focuses light onto an illuminating region on the wafer S. Light L′₁ has polarization either substantially perpendicular to the via walls (in the depth measurement mode of the system), or 45 degrees oriented relative to the via walls (in the profile measurement mode of the system). Light L₂ reflected (returned) from the illuminated region propagates along the detection channel C₂ trough optics 18 and the beam splitter 16 and transmitted thereby to the polarizer 106B. Orientation of the polarizer 106B relative to incident-path polarizer 106A could provide desired polarizations condition, suitable for via depth or via profile as mentioned above. The so-polarized light L′₂ propagates to a spectrometer in the detection unit 104.

The control unit 108 receives data indicative of the detected light and operates as described above, namely processes the oscillations of interference pattern to determine the via depth, or applies model fitting procedure (library based and/or RTR) to said data to determine one or more parameters of the via profile.

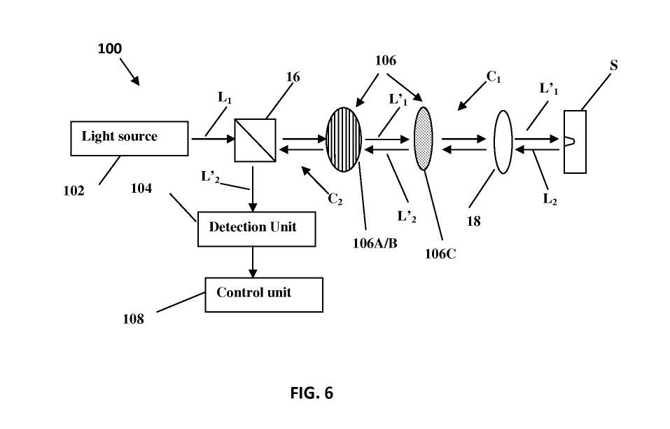

FIG. 5 exemplifies another possible configuration of a measurement system 100. This system is configured generally similar to the above example of FIG. 4, namely includes an illumination unit 102 (which may be constituted by a light emitting arrangement or by a light guiding unit associated with an external light emitter) which defines illumination channel C₁ and preferably produces broadband illumination, a detection unit 104 which defines detection channel C₂ and preferably includes a spectrometer and an imager as described above, a polarization orientation system 106, and a control unit 108. In this example the polarization orientation system 106 includes controllable polarizers 106A and 106B in the illumination and detection channels respectively, and also includes a controllable phase retarder 106C, which is located in the common part of the illumination and detection channels and affects the phase of light propagating in these channels. In this case, the required orientations of the polarizations of incident and detected light are defined and controlled by the control unit as described above for the desired operation mode(s) using controllable polarizers 106A and 106B along with controllable retarder 106C. Desired orientation of the incident light polarization with respect to the via walls could be provided by the controllable retarder 106C along with polarizer 106C.

Thus, light L₁ from the illumination system 102 passes through the polarizer 106A, and polarized light L′₁ is reflected by a beam splitter 16 onto the phase retarder 106C. For cross polarizations or close thereto gray field mode phase retarder 106C is configured to rotate the light polarization by θ=45°, and the so-produced light L″₁ is focused by objective L₁ onto the wafer. Returned (reflected) light L₂ is collected by lens unit 18 onto the phase retarder 106C, and its phase is again rotated by 45°, resulting in light L′₂ which then passes the polarizer 106B in the detection path C₂. For cross polarizations mode, the polarizer 106B has the same orientation of the preferred plane of polarization as the polarizer 106A.

For bright field mode, the polarizers 106A and 106B have the substantially the same orientation and the phase retarder 106C is configured not to affect the polarizations of light in both illumination and detection paths.

It should be noted, although not specifically illustrated that, generally, the above described system 100 in any example thereof may be configured for implemented any of two measurement mode, i.e. depth measurement or profile measurement.

FIG. 6 shows such an example, the polarization orientation system 106 includes a single polarizer 106A/B and a phase retarder 106C, where the polarizer 106A/B is located between the beam splitter 16 and the phase retarder 106C. Such configuration provides similar optical performance but at a lower cost and with a reduced alignment requirements (e.g. between the polarizer and analyzer).

For the via profile measurements the retarder 106C is configured to rotate the light polarization by θ=45° and the so-produced light L″₁ is focused by objective L₁ onto the wafer. Returned (reflected) light L₂ is collected by lens unit 18 onto the phase retarder 106C, and its phase is again rotated by 45°, resulting in 90° total phase rotation relative to illumination light polarization. Resulting light L′₂ then passes once more the polarizer 106A/B in the detection path C₂, and deflected by beam splitter 16 towards the detection unit 104.

For bright field mode, suitable for via depth measurements the phase retarder 106C is configured not to affect the polarizations of light in both illumination and detection paths and the single polarizer 106A/B is configured (oriented) to provide illuminating light polarized perpendicular to the via wall. The gray field mode also suitable or via depth measurements, the retarder 106C could be configured to rotate the light polarization by θ close to 45°.

Thus, the present invention provides an effective and simple technique for measuring the annularly-shaped vias depth and profile parameters in patterned structures.

Those skilled in the art will readily appreciate that various modifications and changes can be applied to the embodiments of the invention hereinbefore described without departing from its scope defined in and by the appended claims.

1. A measurement system for use in measuring in patterned structures having annularly-shaped vias, the system comprising:
an illumination system defining an illumination channel for directing illuminating light to be incident onto an illumination spot in a measurement site in the structure under measurements,
a detection system defining a detection channel for collecting light returned from the illuminated spot,
a polarization orientation system configured and operable for providing at least one of a first polarization orientation condition corresponding to a first measurement mode enabling determination a depth of the via, and a second polarization orientation condition corresponding to a second measurement mode enabling determination of one or more parameters of a profile of the via, the first and second polarization orientation conditions defining first and second predetermined orientations respectively for polarization of the incident light relative a sidewall of the via;
a navigation system configured and operable to provide controllable relative displacement between the illumination spot and the structure to satisfy an alignment condition such that a center of the illumination spot is aligned with a center of a trench of the via; and
a control unit connectable to output of the detection unit for receiving and processing data indicative of the detected light and connectable to the polarization orientation system to provide said at least one of the first and second polarization conditions, and to the navigation system to control said relative displacement.

2. The measurement system of claim 1, comprising a light focusing and collecting arrangement configured to provide a desirably small illumination spot.

3. The measurement system of claim 1, wherein said illumination and detection systems are characterized by numerical aperture is about 0.02.

4. The measurement system of claim 1, wherein the illumination system comprises a broad band light source, and the detection system comprises a spectrometer, data indicative of the detected light being in the form of a spectral signature.

5. The measurement system of claim 1, wherein the illumination and detection channels are oriented to provide a normal incidence measurement mode.

6. The measurement system of claim 1, wherein the detection unit comprises an imager configured and operable to generate image data indicative of an image of a measurement site, the control unit being configured for processing the image data to identify orientation of the side wall of the via and operate the polarization orientation system accordingly.

7. The measurement system of claim 1, wherein the first and second polarization orientation conditions define first and second relations respectively between the polarization of the incident light and polarization of the detected light.

8. The measurement system of claim 7, wherein the first relation corresponds to bright field condition for the incident and detected light, and second relation corresponds to cross-polarized condition for the incident and detected light

9. The measurement system of claim 7, wherein the first relation corresponds to close cross-polarized condition for the incident and detected light and second relation corresponds to cross-polarized condition for the incident and detected light.

10. The measurement system of claim 1, wherein the polarization orientation system comprises a first polarizer located in the illumination channel, and a second polarizer located in the detection channel.

11. The measurement system of claim 1, wherein the polarization orientation system comprises a phase retarder located in a common part of the illumination and detection channels.

12. A method for use in measuring in patterned structures having annularly-shaped vias, the method comprising:
aligning a focused broad band light illuminating beam with a center of a trench of the via,
affecting polarization of illuminating light beam defining a predetermined orientation for polarization of the incident light relative a sidewall of the via;
providing a predetermined orientation of polarization for the returned light;
detecting the returned light, from the illuminated structure, and
determining of one or more parameters of a profile of the via or a depth of the via.

13. The method of claim 12, wherein said predetermined orientation for polarization of the incident light relative a sidewall of the via corresponds to substantially perpendicular polarization of the incident light relative to the via walls.

14. The method of claim 12, wherein said predetermined orientation for polarization of the incident light relative a sidewall of the via corresponds to 45 degrees orientation of the polarization of the incident light relative to the via walls.

15. The method of claim 12, further comprising providing a certain relation between the polarization of the incident light and polarization of the detected light.

16. The method of claim 15, wherein said certain relation corresponds to close bright field condition for the incident and detected light.

17. The method of claim 15, wherein said certain relation corresponds to close cross-polarized condition for the incident and detected light.

18. The method of claim 15, wherein certain relation corresponds to cross-polarized condition for the incident and detected light.
